(19) United States
(12) Patent Application Publication
(10) Pub. No.: US 2025/0269951 A1
(43) Pub. Date: Aug. 28, 2025

(54) ADJUSTABLE FLOOR MODULE FOR A FUSELAGE PORTION OF AN AIRCRAFT, PARTICULARLY A NOSE CONE, AND METHOD FOR INCORPORATING SUCH A FLOOR MODULE

(71) Applicant: Airbus Operations (S.A.S.), Toulouse (FR)

(72) Inventors: Damien Aguera, Toulouse (FR); Matthieu de Kergommeaux, Toulouse (FR); Salim Chalqi, Toulouse (FR); Yannick Lampure, Toulouse (FR); Alain Mady, Toulouse (FR)

(21) Appl. No.: 19/059,416

(22) Filed: Feb. 21, 2025

(30) Foreign Application Priority Data
Feb. 22, 2024 (FR) FR2401735

(51) Int. Cl. B64C 1/18; B64C 1/06; B64F 5/10

(52) U.S. Cl. CPC B64C 1/18; B64C 1/0683; B64F 5/10

(57) ABSTRACT

A floor module includes a forward sub-module and a aft sub-module arranged relative to each other in a longitudinal direction of the floor module, the sub-modules connected together by connecting elements configured to allow relative movement between the sub-modules at least in the longitudinal direction and to allow the transmission of forces between the sub-modules in a vertical direction substantially orthogonal to the floor module without generating relative movement, the sub-modules thus connected by the connecting elements being structurally decoupled, that is, they can be moved slightly relative to each other, which makes it possible to adjust the geometry of the floor module, for example to overcome tolerance defects of the fuselage portion on which it is intended to be installed.

### TECHNICAL FIELD

The disclosure herein relates to an adjustable floor module for a fuselage portion of an aircraft, particularly for a nose cone, and a method for incorporating such a floor module.

### BACKGROUND

In order to manufacture certain portions of an aircraft, particularly of a transport plane, it is known practice to use modular assembly processes. These are processes comprising the assembly of a plurality of parts to form modules (preferably a small number thereof) which are in turn then assembled with each other in order to obtain the desired aircraft portion. This can make it possible to optimize certain assembly steps, in particular due to the setting up of dedicated workstations that can operate in parallel.

For example, the manufacturing of a nose cone of an aircraft can correspond to a process that firstly calls for the assembly of a plurality of parts in order to manufacture several modules independently, such as fuselage portions and a floor module. The fuselage portions are then assembled with each other to form a fuselage body into which the floor module is introduced and fastened. This makes it possible to save time and increase efficiency.

However, in the manufacturing process in question, the floor module is fastened to two different fuselage parts, which can pose a problem with respect to tolerances. The fuselage body can have alignment defects (generally inherent in the assembly steps) resulting in slight misalignments between the fuselage parts. As a result, the step of fastening the floor module into the fuselage body can be complicated.

There is therefore a need to find a solution that makes it possible to improve the aforementioned assembly processes.

### SUMMARY

The disclosure herein aims to overcome the aforementioned drawbacks. It relates to a floor module for a fuselage portion of an aircraft, particularly a nose cone, the floor module having a longitudinal direction.

According to the disclosure herein, the floor module comprises at least one so-called forward sub-module and one so-called aft sub-module arranged longitudinally relative to each other, forward and aft being defined in opposite senses in the longitudinal direction of the floor module, the sub-modules being connected together by a plurality of connecting elements configured to allow relative movement between the sub-modules at least in the longitudinal direction and to allow the transmission of forces between the sub-modules in a vertical direction substantially orthogonal to the floor module, without generating relative movement between the sub-modules.

Due to the disclosure herein, it is thus possible to obtain, simply and at a lower cost, a floor module formed by sub-modules that are structurally decoupled, that is, they are connected together by the connecting elements so that they can be moved slightly relative to each other at least longitudinally, which makes it possible to adjust the floor module geometry, for example in order to overcome tolerance defects of the fuselage portion in which it is intended to be installed.

In an embodiment, each of the connecting elements comprises at least two fastening lugs arranged respectively at a forward end of the aft sub-module and at an aft end of the forward sub-module, and a link provided with two articulations, the link being arranged between the fastening lugs and connected to each of them by one of its articulations.

Advantageously, for each of the connecting elements, one of the fastening lugs is rigidly connected to one end of a rail of the aft sub-module and the other fastening lug is rigidly connected along an aft cross-beam of the forward sub-module.

In addition, advantageously, each of the articulations of the link of each of the connecting elements comprises at least one articulation pin arranged in the corresponding fastening lug and on which the link is mounted so as to form at least one simple hinged connection between the link and the corresponding fastening lug.

In another particular embodiment, the connecting elements are configured to also allow relative movement between the sub-modules in a transverse direction substantially orthogonal to the longitudinal direction and substantially parallel to the floor module.

In addition, advantageously, each of the articulations of the link of each of the connecting elements comprises at least one ball joint mounted on an articulation pin arranged through the corresponding fastening lug, the ball joint being gripped between two spacers having a suitable shape so as to form at least one ball joint connection between the link and the corresponding fastening lug.

The disclosure herein also relates to a fuselage portion of an aircraft comprising at least one fuselage body formed by a plurality of fuselage parts.

According to the disclosure herein, the fuselage portion comprises at least one floor module as described above, arranged inside the fuselage body, the forward sub-module and the aft sub-module of the floor module each being fastened to different fuselage parts.

In a preferred embodiment, the fuselage portion corresponds to a nose cone of the aircraft.

The disclosure herein also relates to a method for incorporating a floor module as described above into a fuselage portion.

According to the disclosure herein, the method comprises at least the following set of steps:
a preliminary assembly step in order to connect together the forward sub-module and the aft sub-module using a plurality of connecting elements so as to obtain the floor module;
a mounting step in order to introduce the floor module obtained in the preliminary assembly step into the fuselage body of the fuselage portion; and
a fastening step in order to fasten the floor module to the fuselage body, the forward sub-module and the aft sub-module each being fastened to different fuselage parts.

The disclosure herein further relates to a process for assembling a fuselage portion of an aircraft, particularly a nose cone, comprising at least the following set of steps:
a series of assembly steps in order to assemble a plurality of fuselage parts of the fuselage portion so as to obtain a fuselage body; and
an incorporation step in order to incorporate at least one floor module into the fuselage body obtained in the series of assembly steps, the incorporation step corresponding to the incorporation method described above.

### BRIEF DESCRIPTION OF THE DRAWINGS

The appended figures will make it clear how the disclosure herein can be carried out. In the figures, identical reference signs denote similar elements.

FIG. 1 is a schematic partially cross-sectional perspective view of a nose cone of an aircraft comprising a particular embodiment of a floor module.

FIG. 2 is a schematic perspective view of the nose cone in FIG. 1, seen from the rear.

FIG. 3 is a partial schematic perspective view of the floor module showing an interface between a forward sub-module and an aft sub-module connected together by a plurality of connecting elements.

FIG. 4 is a detailed perspective view of a particular embodiment of one of the connecting elements in FIG. 3.

FIG. 5 is a detailed perspective view of an articulation of the connecting element in FIG. 4.

FIG. 6 is a schematic view of a particular embodiment of a process for assembling a nose cone of an aircraft.

FIG. 7 is a schematic view of a particular embodiment of a method for incorporating a floor module into a nose cone of an aircraft.

FIG. 8 is a block diagram of a process for assembling a fuselage portion of an aircraft comprising a method for incorporating a floor module.

### DETAILED DESCRIPTION

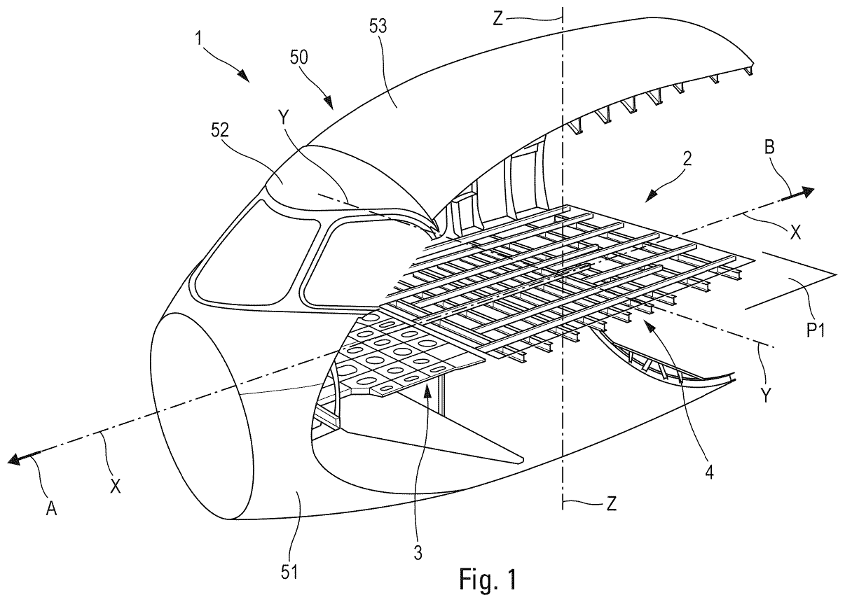

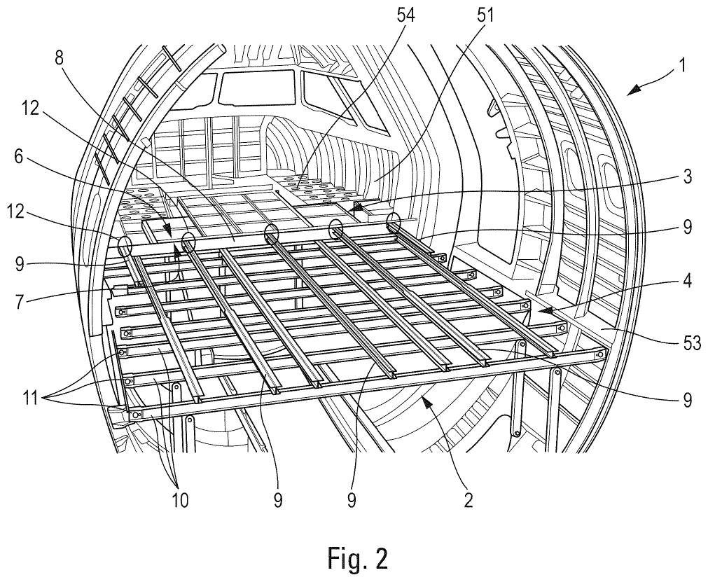

A nose cone 1 of an aircraft comprising a floor module 2 and making it possible to illustrate the disclosure herein is shown in FIG. 1 and FIG. 2 in a particular embodiment. The floor module 2 is adjustable, that is, it can be adjusted slightly, as explained below, so as to adapt, if necessary, to potential tolerance defects of the nose cone 1.

The nose cone 1 corresponds to the forward portion of the aircraft comprising at least the cockpit and, in general, also comprising a fuselage portion provided with the forward side access doors of the aircraft.

The floor module 2 corresponds to a portion of the floor of the aircraft intended to be fastened to the inside of the nose cone 1. It comprises at least one framework formed in particular by rails and cross-beams on which floor panels and equipment such as seats or monuments (not shown in FIG. 1 and FIG. 2) are intended to be fastened.

In the context of the disclosure herein, the floor module 2 is particularly suitable for being installed in a nose cone of an aircraft, as described above. However, in other embodiments, the floor module 2 can be intended to be installed in another fuselage portion of the aircraft, for example in a fuselage portion situated longitudinally more towards the middle of the aircraft, and more particularly above the wing box, or, according to another example, in a tail cone. “Fuselage portion” is given to mean one or more consecutive sections forming a portion of the fuselage of the aircraft.

As shown in FIG. 1, a plane P1 is considered, formed by:
a longitudinal direction oriented along a longitudinal axis X-X of the nose cone 1 (and of the aircraft); and
a transverse direction oriented along a transverse axis Y-Y orthogonal to the longitudinal axis X-X.

The floor module 2 has a generally flat shape and is arranged in the nose cone 1 so that it is substantially parallel to the plane P1. FIG. 1 also shows a vertical direction oriented along a vertical axis Z-Z that is orthogonal to the plane P1. The direction Z corresponds to a vertical direction when the aircraft is on the ground.

In an embodiment, shown in FIG. 1 to FIG. 3, the floor module 2 comprises a forward sub-module 3 and an aft sub-module 4 arranged longitudinally relative to each other.

In the context of the disclosure herein, the terms “forward” and “aft” denote opposite senses in the longitudinal direction. The forward sense, represented by an arrow A (FIG. 1), is defined towards the front of the nose cone 1, and the aft sense, represented by an arrow B (FIG. 1), is defined towards the rear of the nose cone 1.

The sub-module 3 corresponds to the forward portion of the floor module 2, intended to be arranged towards the forward end of the nose cone 1. The sub-module 3 is the portion on which the elements of the cockpit are intended to be installed.

The sub-module 4 corresponds to the aft portion of the floor module 2, which is arranged longitudinally behind the sub-module 3. The sub-module 4 is the portion on which equipment, such as seats or monuments, is intended to be installed.

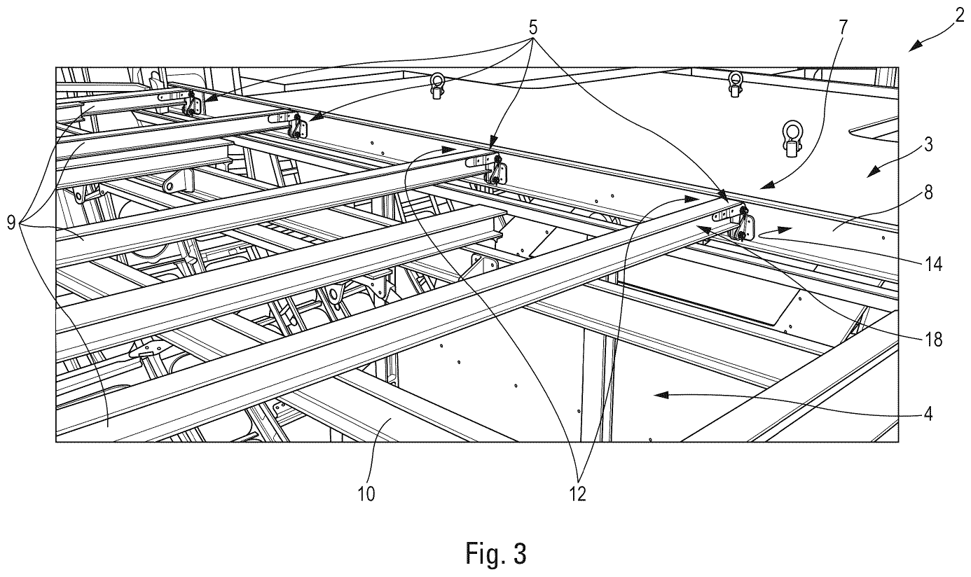

The sub-modules 3 and 4 are arranged end to end and attached to each other in order to form the floor module 2. More specifically, as shown in detail in FIG. 2 and FIG. 3, the floor module 2 comprises a plurality of connecting elements 5 arranged between an aft end 6 of the sub-module 3 and a forward end 7 of the sub-module 4 so that they connect the sub-modules 3 and 4 together.

The sub-module 3 comprises a structure in the form of a grid comprising cross-beams, and in particular an aft cross-beam 8 arranged transversely at the aft end 6 of the sub-module 3. The aft cross-beam 8 is configured to make it possible to fasten the connecting elements 5 to the sub-module 3, and, as is common practice, to form part of the fastening of the sub-module 3 to the fuselage body of the nose cone 1 (by standard fasteners not shown).

The sub-module 4 also comprises a structure in the form of a grid comprising rails 9 and cross-beams 10. The cross-beams 10 extend transversely from one side to the other of the sub-module 4. Each cross-beam 10 comprises at its ends fastening holes 11 configured to make it possible to fasten the sub-module 4 to the fuselage body of the nose cone 1. The rails 9 are arranged on the cross-beams 10 and extend longitudinally relative to the sub-module 4 so that each rail 9 has one end 12 (circled in FIG. 2) extending towards the forward end 7 of the sub-module 4. The ends 12 are configured to make it possible to fasten the connecting elements 5 to the sub-module 4.

In the particular embodiment shown in FIG. 2, the rails 9 are not all the same length; some extend over the entire length of the sub-module 4 and others over only part of it. In addition, in this particular embodiment, the structure of the sub-module 4 comprises other rails, similar to the rails 9, but that do not contribute to the connection between the sub-modules 3 and 4.

As shown in FIG. 3, the sub-modules 3 and 4 are arranged so that the end 12 of each rail 9 is facing the cross-beam 8 substantially perpendicularly thereto. Each connecting element 5 forms the connection between the sub-modules 3 and 4, being fastened both to the cross-beam 8 and to one of the rails 9.

In the particular embodiment shown in FIG. 3 and FIG. 4, each connecting element 5 comprises a first fastening lug 13 configured to be rigidly connected to the cross-beam 8. The fastening lug 13 comprises a support 14, in the form of a plate, arranged against an aft face 15 of the aft cross-beam 8. The support 14 is provided with holes 16 to allow standard fastening elements (not shown) such as bolts or rivets to pass through the support 14 and the cross-beam 8.

In addition, each connecting element 5 comprises a second fastening lug 17 configured to be rigidly connected to one of the rails 9. The fastening lug 17 is formed by two symmetrical tongues 17A and 17B, which are arranged on either side of the corresponding rail 9 in the continuation of the rail 9. In the particular embodiment under consideration, the rails 9 have an I-shaped cross-section (I-beam) comprising a central web 18. The tongues 17A and 17B are arranged on either side of the rail 9 against the central web 18. The tongues 17A and 17B each comprise holes 19 to allow standard fastening elements (not shown) such as bolts or rivets to pass through the tongues 17A and 17B and the central web 18.

Each connecting element 5 further comprises a link 20 configured to form a connection between the fastening lugs 13 and 17. To this end, the link 20 is connected to each of the fastening lugs 13 and 17 by an articulation. As described in detail below, the connecting elements 5 thus make it possible to connect the sub-modules 3 and 4 together, while permitting relative movement between the sub-modules 3 and 4.

In the particular embodiment shown in FIG. 4, for each connecting element 5, a first end 21 of the link 20 is connected to the fastening lug 13 by a first articulation 27 and a second end 24 of the link 20 is connected to the fastening lug 17 by a second articulation 28.

For the articulation 27, the fastening lug 13 comprises two tabs 22 and 23 extending perpendicularly to the plate of the support 14 so that they form a protruding fork. The end 21 is mounted between the tabs 22 and 23 so as to allow the arrangement of the articulation 27, as described below. In FIG. 4, the tabs 22 and 23 of the fastening lug 13 are shown transparently for improved understanding of the arrangement of the articulation 27.

For the articulation 28, the fastening lug 17 comprises two tabs 25 and 26 extending longitudinally in the continuation of the tongues 17A and 17B respectively level with the end 12 of the corresponding rail 9 so that they form a protruding fork. The end 24 of the link 20 is mounted between the tabs 25 and 26 so as to allow the arrangement of the articulation 28.

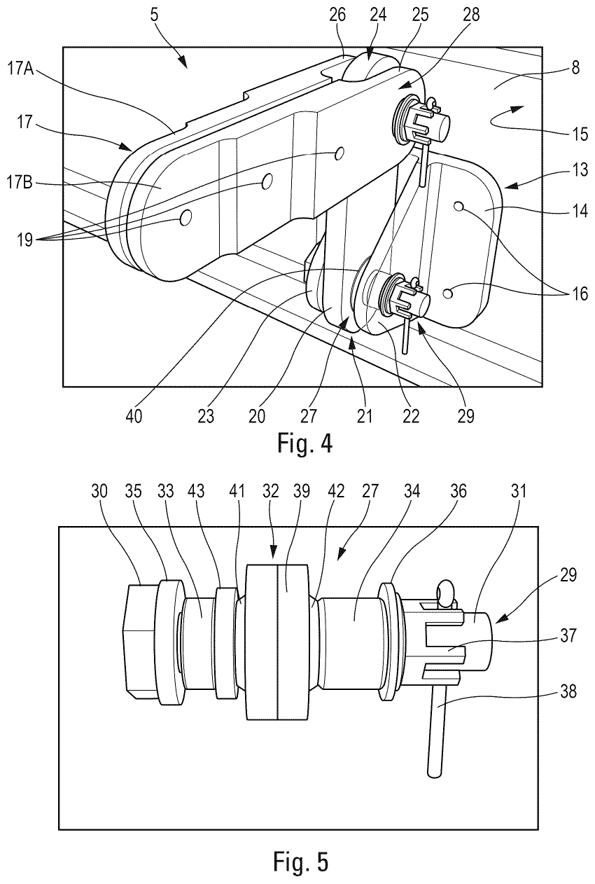

In the particular embodiment in FIG. 4, the articulation 27 is provided with a pin 29 arranged so that it passes through the tabs 22 and 23 of the fastening lug 13 and the end 21 of the link 20. As shown in detail in FIG. 5, the pin 29 comprises a head 30 arranged on the side of the tab 23 and configured to form a translational stop against the tab 23. At the opposite end to the head 30, the pin 29 comprises a threaded end 31 protruding on the side of the tab 22.

The articulation 27 further comprises a ball joint 32 gripped between two spacers 33 and 34, all mounted on the shaft 29. The ball joint 32 is provided with a central hole to allow the pin 29 to pass through. In addition, the ball joint 32 is mounted, on its periphery 39, in the link 20. To this end, the periphery 39 of the ball joint has a cylindrical shape crimped into a hole 40 (FIG. 40) made in the end 21 of the link 20.

The spacers 33 and 34 are arranged on the pin 29 on each side of the ball joint 32. As shown in the transparent view in FIG. 4, openings are provided in the tabs 22 and 23 to allow the pin 29 to pass through and to receive the spacers 33 and 34. Furthermore, the spacer 33 has, in particular, a shoulder 43 configured to bear against the tab 23.

The articulation 27 also comprises washers 35 and 36 and a nut 37 screwed onto the threaded end 31 of the pin 29 in order to fasten the articulation 27 between the tabs 23 and 23 of the fastening lug 13. The washer 35 is interposed between the head 30 of the pin 29 and the tab 23, and the washer 36 is interposed between the nut 37 and the tab 22. In the particular embodiment in FIG. 5, the nut 37 is a slotted nut that is locked, as is common practice, by a split pin 38 when the nut 37 is screwed onto the pin 29 to fasten the articulation 27.

The ball joint 32 and the spacers 33 and 34, thus mounted on the pin 29 between the tabs 22 and 23, are configured to obtain a ball-joint connection between the link 20 and the fastening lug 13. The ball joint 32 has, one on either side, two hemispherical portions 41 and 42 respectively facing the spacer 33 and the spacer 34. In addition, the spacers 33 and 34 have shapes suitable for interacting with these hemispherical portions 41 and 42 so as to permit rotations of the ball joint 32 with three degrees of freedom.

In the particular embodiment under consideration in the present description, the articulation 28 is identical to the articulation 27 and is arranged similarly between the end 24 of the link 20 and the fastening lug 17. However, in other embodiments, the articulations 27 and 28 can be different from each other.

By the connecting elements 5 described above, a floor module 2 is thus obtained that is formed by two sub-modules 3 and 4 that are structurally decoupled. “Structurally decoupled” is given to mean that when the sub-modules 3 and 4 are connected together by the connecting elements 5, they can be moved slightly relative to each other, at least longitudinally and/or transversely.

In the embodiment described above, in which the articulations 27 and 28 form ball-joint connections, the connecting elements 5 allow relative movement in the longitudinal direction (X-X) and relative movement in the transverse direction (Y-Y). As a result, the sub-modules 3 and 4 can be moved relative to each other from front to rear and also laterally (that is, transversely).

In addition, the connecting elements 5 also allow the transmission of forces between the sub-modules 3 and 4 in the vertical direction (Z-Z) without generating relative movement. Certain operations can thus be performed that require the application of mechanical stresses to the floor module 2, such as for example the installation of monuments, without moving the sub-modules 3 and 4 relative to each other.

It will be noted that the configuration of the connecting elements 5, as described above, assumes kinematics in which a longitudinal or transverse movement of one of the sub-modules 3 or 4 relative to the other results in a slight vertical relative movement. However, this vertical relative movement is negligible compared to the longitudinal and/or transverse movement. As a result, the connecting elements 5 are considered to prevent relative movement in the vertical direction (Z-Z) between the sub-modules 3 and 4.

The amplitude of the movements between the sub-modules 3 and 4 permitted by the connecting elements 5 depends on their dimensions and in particular on the dimensions of the links 20 and the ball joints 32. In the preferred application under consideration, namely a floor module for a nose cone of an aircraft, the connecting elements 5 are configured to obtain relative movement between the sub-modules 3 and 4 of the order of a few millimetres, for example up to 10 mm. In other embodiments, this amplitude can be greater than 10 mm.

The structural decoupling of the sub-modules 3 and 4 makes it possible to adjust their relative positions longitudinally and transversely. This can allow a slight adjustment on the overall geometry of the floor module 2 to adapt it to the fuselage portion in which it is intended to be installed. For example, in the context of the incorporation of the floor module 2 into a fuselage portion such as the nose cone 1, this can make it possible to overcome the difficulties of assembly linked to alignment problems caused, for example, by tolerance defects, as described in greater detail below.

An additional advantage of the structural decoupling of the sub-modules 3 and 4 is that of preventing the transmission of undesirable forces between the forward and aft portions of the floor module 2. The connecting elements 5 are configured so that, when one of the sub-modules 3 or 4 is subjected to forces in the longitudinal direction (X-X) and/or the transverse direction (Y-Y), for example inertial forces, these forces are entirely redirected to the fuselage of the aircraft, via the fastenings of the sub-module 3 or 4, rather than being transmitted to the other sub-module.

In the embodiment described above, the articulations 27 and 28 are formed in a particular way in order to obtain ball joint connections. This configuration is not limiting, and the articulations 27 and 28 can be formed in different ways. For example, in one variant embodiment (not shown), the articulations 27 and 28 can be configured to obtain hinged connections, that is, a rotating connection with a single degree of freedom, instead of the ball joints.

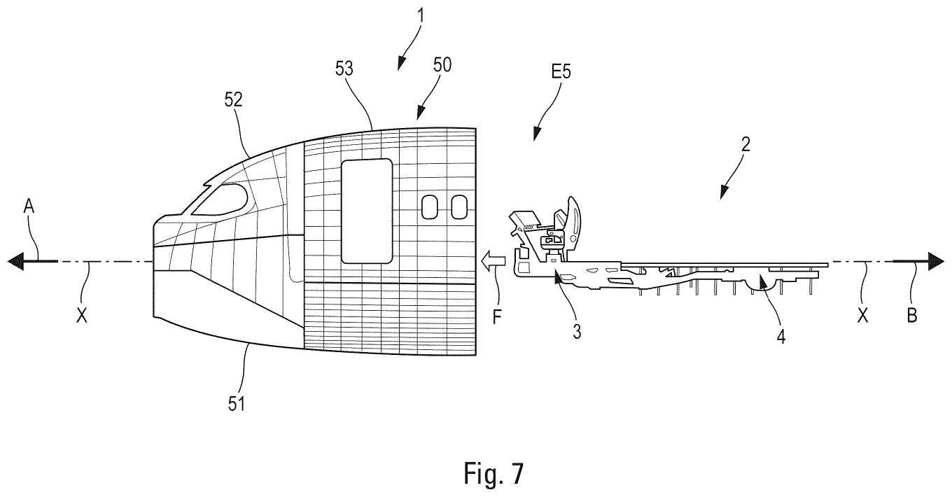

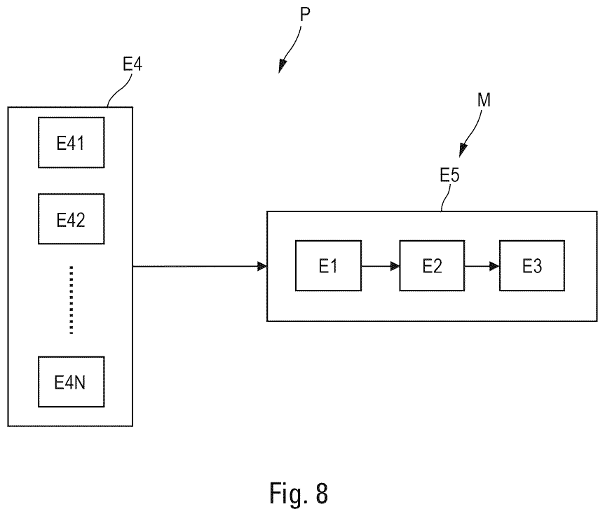

The floor module 2 as described above can be incorporated into a fuselage portion of an aircraft, such as the nose cone 1, by implementing an incorporation method M shown schematically in FIG. 7 and FIG. 8. The method M comprises a preliminary assembly step E1, a mounting step E2 and a fastening step E3.

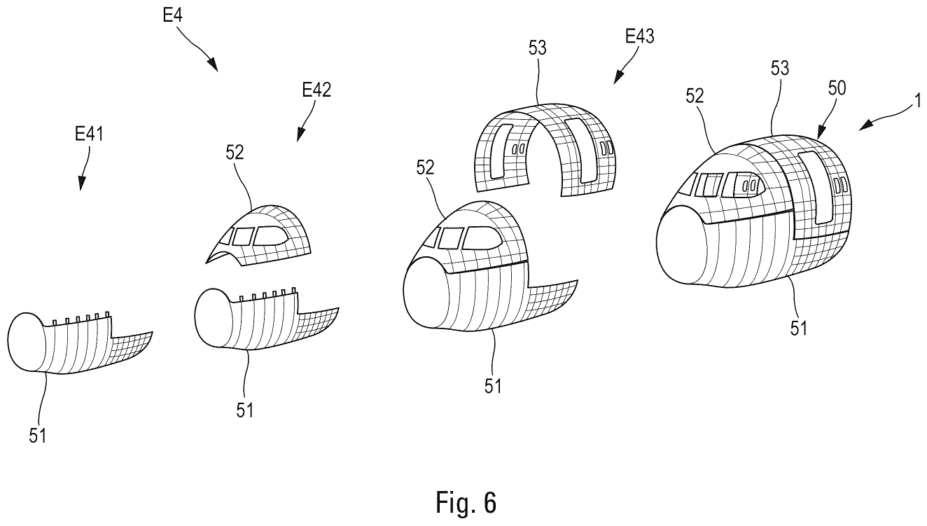

In the context of the disclosure herein, a fuselage portion corresponds to a longitudinal portion of an aircraft (for example one or more fuselage sections), obtained by assembling a plurality of fuselage parts to form a fuselage body. In a preferred embodiment, shown in FIG. 6 and FIG. 7, the fuselage portion corresponds to the nose cone 1. This nose cone 1 comprises a fuselage body 50 formed by the assembly of parts 51, 52 and 53 manufactured and assembled prior to the implementation of the method M.

Step E1 comprises the manufacturing of the floor module 2. The sub-modules 3 and 4 are manufactured independently of each other. They are then assembled by being connected together by a plurality of connecting elements 5 so as to obtain the floor module 2.

Step E2 comprises the introduction of the floor module 2 obtained in step E1 into the fuselage body 50 of the nose cone 1. The floor module 2 is introduced by inserting it through the rear of the nose cone 1, as illustrated by an arrow F in FIG. 7. During step E2, the fastening points of the floor module 2 are placed facing the fastening points of the fuselage body 50, provided for fastening the floor module 2. The fastening points of the fuselage body 50 are distributed over several of the parts 51, 52 and 53.

Step E3 comprises fastening the floor module 2 to the fuselage body 50. The sub-modules 3 and 4 of the floor module 2 are each fastened to one of the different parts 51, 52, 53.

This method M for incorporating a floor module 2 into a fuselage portion, such as the nose cone 1, is particularly suitable for being implemented in a process P for assembling the fuselage portion. The process P, shown schematically in FIG. 7 and FIG. 8, comprises a series E4 of steps E41, E42 and E43 of assembling fuselage parts and a step E5 of incorporating the floor module 2.

Steps E41, E42 and E43, illustrated in FIG. 7, correspond to steps of assembling the parts 51, 52 and 53 to form the fuselage body 50. The number N of steps E41, . . . , E4N of the series E4 depends in particular on the number of parts necessary to form the fuselage body 50. In other embodiments than the one shown in FIG. 7, the series E4 can thus comprise more than three steps.

Step E5 comprises the incorporation of the floor module 2 into the fuselage body 50 formed by the series E4 of steps. This step E5 corresponds to the implementation of the method M as described above.

As in any assembly process, in particular for parts as large as fuselage parts, it is possible that tolerance defects become apparent during the assembly of the parts 51, 52 and 53. There can be slight deformations or slight misalignments between the parts 51, 52 and 53 when they are assembled, which result in the fastening points provided on the parts 51, 52 and 53 and the fastening points of the floor module 2 coinciding with each other approximately. The assembly of the floor module 2 can then be complex and waste labour time.

The floor module 2 and the method M for incorporating the floor module 2 make it possible to overcome these difficulties. Because the floor module 2 is adjustable, the sub-modules 3 and 4 can adapt to defects such as defects in the alignment of the fastening points. Once one of the sub-modules, for example the sub-module 3, has been fastened to the fuselage part on which it is intended to be fastened, the sub-module 4 can be adjusted by being moved slightly longitudinally and/or transversely as required. It is thus easy to adjust the position of the sub-module 4 so as to align the fastening points thereof with the fastening points of the fuselage part to which it must be fastened, even if the fuselage body 50 comprises tolerance defects.

The floor module 2 as described above, which makes it possible to implement the method M and the process P, has a number of advantages: In particular:
it makes it possible to structurally decouple the sub-modules 3 and 4 so as to permit relative movement between them, longitudinally and transversely;
it makes it possible to overcome the assembly difficulties linked to defects that become apparent during the assembly steps;
it makes it possible for forces to be transmitted between the sub-modules 3 and 4 vertically without generating relative movement between the sub-modules 3 and 4;
it makes it possible to decouple the transmission of forces between the sub-modules 3 and 4 longitudinally and transversely;
it makes it possible to simplify the incorporation of the floor module 2 into a fuselage portion and thus reduce costs, in particular by saving labour time; and
it is simple and low-cost to implement as it does not require significant modifications compared to a standard floor module.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A floor module for a fuselage section of an aircraft, or for a nose cone, the floor module having a longitudinal direction, and comprising:
at least one forward sub-module and one aft sub-module arranged longitudinally relative to each other, forward and aft being defined in opposite senses in the longitudinal direction of the floor module, the sub-modules being connected together by a plurality of connecting elements configured to allow relative movement between the sub-modules at least in the longitudinal direction and to allow transmission of forces between the sub-modules in a vertical direction substantially orthogonal to the floor module, without generating relative movement between the sub-modules.

2. The floor module according to claim 1, wherein each of the connecting elements comprises at least two fastening lugs arranged respectively at a forward end of the aft sub-module and at an aft end of the forward sub-module, and a link provided with two articulations, the link being arranged between the fastening lugs and connected to each of them by one of its articulations.

3. The floor module according to claim 2, wherein, for each of the connecting elements, one of the fastening lugs is rigidly connected to one end of a rail of the aft sub-module and another fastening lug is rigidly connected along an aft cross-beam of the forward sub-module.

4. The floor module according to claim 2, wherein each of the articulations of the link of each of the connecting elements comprises at least one articulation pin arranged in a corresponding fastening lug and on which the link is mounted to form at least one simple hinged connection between the link and the corresponding fastening lug.

5. The floor module according to claim 4, wherein the connecting elements are configured to also allow relative movement between the sub-modules in a transverse direction substantially orthogonal to the longitudinal direction and substantially parallel to the floor module.

6. The floor module according to claim 5, wherein each of the articulations of the link of each of the connecting elements comprises at least one ball joint mounted on the articulation pin and gripped between two spacers having a suitable shape to form a ball joint connection between the link and the corresponding fastening lug.

7. A fuselage portion of an aircraft comprising at least one fuselage body formed by a plurality of fuselage parts, comprising at least one floor module according to claim 6, arranged inside the fuselage body, the forward sub-module and the aft sub-module of the floor module each being fastened to different fuselage parts.

8. The fuselage portion according to claim 7, wherein it corresponds to a nose cone of the aircraft.

9. A method for incorporating the floor module according to claim 1 into a fuselage portion of an aircraft, comprising at least:
a preliminary assembly step to connect together the forward sub-module and the aft sub-module using a plurality of connecting elements to obtain the floor module;
a mounting step to introduce the floor module obtained in the preliminary assembly step into the fuselage body of the fuselage portion; and
a fastening step to fasten the floor module to the fuselage body, the forward sub-module and the aft sub-module each being fastened to different fuselage parts.

10. A process for assembling a fuselage portion of an aircraft, or a nose cone, comprising at least:
a series of assembly steps to assemble a plurality of fuselage parts of the fuselage portion to obtain a fuselage body; and
an incorporation step to incorporate at least one floor module into the fuselage body obtained in the series of assembly steps,
wherein the incorporation step corresponds to the method according to claim 9.
